(19) United States
(12) Patent Application Publication
(10) Pub. No.: US 2014/0083801 A1
(43) Pub. Date: Mar. 27, 2014

(54) Transport Unit for Climbing or Descending a Slope or Stairs

(71) Applicants: Dennis Vroegindeweij, Ursem (NL); Johannes Gerardus Cornelis Hoedjes, Heerhugowaard (NL)

(72) Inventors: Dennis Vroegindeweij, Ursem (NL); Johannes Gerardus Cornelis Hoedjes, Heerhugowaard (NL)

(73) Assignee: HANDICARE STAIRLIFTS B.V., Heerhugowaard (NL)

(21) Appl. No.: 13/978,065

(22) PCT Filed: Jan. 6, 2012
(86) PCT No.: PCT/NL2012/050010

§ 371 Date: Dec. 5, 2013

(30) Foreign Application Priority Data
Jan. 6, 2011 (NL) 2005957

(51) Int. Cl. B66B 9/08

(52) U.S. Cl. CPC B66B 9/08; B66B 9/0815
USPC 187/201

(57) ABSTRACT

Transport unit 1 for climbing or descending a slope or stairs along a rail provided with a strip, the transport unit comprises a main frame 3 and a guide mechanism 5. The guide mechanism 5 may have at least two guides 13 which guide the transport unit along the rail and a drive mechanism with a drive wheel for driving the transport unit along the rail by engaging the strip at an engagement point. The main frame 3 may be suspended from the guide mechanism 5 in a position around, substantially equal and/or lower than the engagement point.

### FIELD OF THE INVENTION

The invention relates to a transport unit for climbing or descending a slope or stairs along a rail provided with a strip, the transport unit comprises a main frame and a guide mechanism, the guide mechanism is provided with at least two guides which guide the transport unit along the rail and a drive wheel for driving the transport unit along the rail by engaging the strip at an engagement point.

### BACKGROUND

EP1125882 discloses a drive mechanism which is substantially ball shaped and is connected to the frame thereby forming a ball joint. A drive wheel is provided in the lower portion of the drive mechanism. The forces of the drive wheel caused on the drive mechanism need to be absorbed by the drive mechanism and since the main frame is suspended from the drive mechanism round the centre of the ball the weight of the main frame does not help in stabilizing the drive mechanism .

WO 2009/078704 discloses a driving mechanism with a drive wheel engaging with a strip. The driving axis of the driving wheel being below the position where the main frame is mounted against the driving mechanism.

### SUMMARY OF THE INVENTION

It is an object of the invention to provide an improved transport unit.

Accordingly there is provided a transport unit for climbing or descending a slope or stairs along a rail provided with a strip, the transport unit comprises a main frame and a guide mechanism, the guide mechanism is provided with at least two guides which guide the transport unit along the rail and a drive wheel for driving the transport unit along the rail by engaging the strip at an engagement point, wherein the main frame is suspended from the guide mechanism in a position around, substantially equal and/or lower than the engagement point with a bearing for rotation of the guide mechanism with respect to the main frame.

By suspending the main frame from the guide mechanism in a position around, substantially equal and/or lower than the engagement point with a bearing for rotation of the guide mechanism with respect to the main frame any forces exerted by the driving wheel may be easily absorbed by the transport unit.

According to a further embodiment there is provided a method for transporting a load along a rail comprising a strip, the method comprising:

engaging a drive wheel provided to a guide mechanism with the strip at an engagement point;

suspending a main frame from the guide mechanism with a bearing being positioned around, substantially equal and/or lower than the engagement point;

rotating the driving wheel so as to drive the guide mechanism along the rail; and,

allowing rotation of the guide mechanism with respect to the mainframe around the bearing.

These and other aspects, features and advantages will become apparent to those of ordinary skill in the art from reading the following detailed description and the appended claims. For the avoidance of doubt, any feature of one aspect of the present invention may be utilised in any other aspect of the invention. It is noted that the examples given in the description below are intended to clarify the invention and are not intended to limit the invention to those examples per se. Numerical ranges expressed in the format “from x to y” are understood to include x and y. When for a specific feature multiple preferred ranges are described in the format “from x to y”, it is understood that all ranges combining the different endpoints are also contemplated.

### BRIEF DESCRIPTION OF THE FIGURES

Embodiments of the invention will be described, by way of example only, with reference to the accompanying schematic drawings in which corresponding reference symbols indicate corresponding parts, and in which:

FIGS. 1a and 1b disclose a transport unit according to an embodiment of the invention;

FIG. 2a discloses a stair lift with the transport unit of FIG. 1 and a chair mounted against it in a vertical bend of a rail;

FIG. 2b discloses a stair lift with the transport unit 1 of FIG. 1 in a horizontal bend of a rail;

FIG. 3 discloses a further embodiment according to the invention;

FIG. 4a discloses a top view, FIG. 4b a front side view, FIG. 4c a bottom view, FIG. 4d a side view and FIG. 4f a back side view on a further embodiment according to the invention; and,

FIGS. 5a and 5b disclose a further embodiment of a transport unit constructed and arranged for climbing or descending a slope or stairs along a rail.

### DETAILED DESCRIPTION OF THE INVENTION

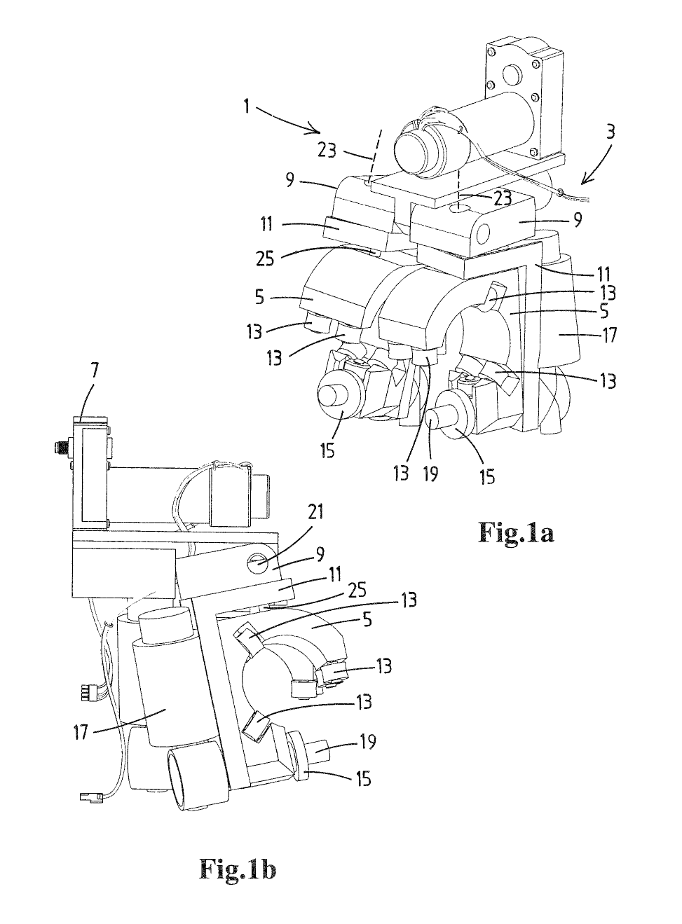

FIGS. 1a and 1b disclose a transport unit 1 according to an embodiment of the invention. The transport unit 1 is constructed and arranged for climbing or descending a slope or stairs along a rail provided with a strip (not shown) and comprises a main frame 3 and a first and second guide mechanism 5. The main frame 3 comprises a carrier frame 7, a first and second intermediate frame 9 and a first and second guide frame 11. The carrier frame 7 and the first and second intermediate frame 9 may be rotatable with respect to each other around axis 21. The first and second intermediate frame 9 may be rotatable connected with the first and second guide frame 11 around axis 23. The guide mechanisms 5 may be provided with guides, e.g. guide wheels 12 and a drive wheel 15. In this embodiment the guide mechanisms 5 may be provided with six guides, alternatively they may be provided with five four, three or two guides. The guides may be wheels or sliders.

The transporting unit 1 may be provided with a driving motor 17 for driving the drive wheel 15 via a driving axis 19. The driving motor 17 may be mounted on the first and/or second guide frame 7 and may drive the driving axis 19 via a gear wheel (not shown in detail). The driving axis may have a bearing in the guide frame 11 and in the guide mechanism 5. In this way the driving axis functions to suspend the guide frame 11 of the main frame from the guide mechanism 5. In this way the transport unit 1 is provided with bearings for rotation of at least one of the guide mechanism 5 around a first axis (through driving axis 19) and second axis 23, the first and second axis being in a plane perpendicular to the rail. Preferably, the first and second axis are substantially in the same plane but they may also be in separate planes. The first and second axis may cross each other in the rail preferably around an engagement point of the drive wheel 15 with the strip. With around an engagement point a distance to the engagement of less than 25 centimetres, preferably less than 10 centimetres and most preferably of less than 5 centimetres is meant. The guide mechanism 5 may be rotatable around the X, Y and Z axis with respect to a load being carried by the main frame 3 on the carrier frame 7 wherein Z is defined in a vertical direction and Y, X in the horizontal plane and with lower is meant lower in the vertical direction.

The transport unit may comprises a protrusion 25 below the first and second guide frame 11 and which is moveable in a slot (not shown) in the top of the guide mechanism 5. The protrusion 25 in the slot may function as an end-stop for the rotation of the guide mechanism 5 around the axis 19 and may provide a connection with the guide frame 11 above the engagement point of the driving wheel 15 so as to compensate for a torque of the guide mechanism 5 with respect to the guide frame 11 in a direction around the rail. A driving moment of the driving wheel 15 during movement of the transport unit 1 may be directly lead out of the guide mechanism 5 to the guide frame 11 via the axis 19 at a position where the main frame may be suspended from the guide mechanism. In this way the influence of the driving momentum on the guide mechanism is minimized. In an alternative embodiment the protrusion may be provided to the guide mechanism 5 and the slot to the guide frame 11.

By suspending the main frame from the guide mechanism 5 in a position around, substantially equal and/or lower than the engagement point with a bearing for rotation of the guide mechanism 5 with respect to the main frame any forces exerted by the driving wheel 15 may be easily absorbed by the transport unit. It is therefore less likely that the guide mechanism may jam with the rail by the driving forces.

Acceleration of the transport unit by rotating the drive wheel 15 may cause a tilting of the transport unit. This may be caused by a center of mass of the transport unit (including load) not being aligned with the engagement point of the drive wheel 15. Such a misalignment may be hard to avoid. By having a bearing for rotation of the guide mechanism 5 with respect to the main frame such a tilting of the main frame may not tilt the guide mechanism 5. Jamming of the guide mechanism 5 with the rail is therefore less likely to occur during acceleration.

By connecting with a bearing for rotation the first and second intermediate frame 9 rotatable with the first and second guide frame 11 around axis 23 at a position around or substantially equal in the horizontal plane with the engagement point, forces exerted by the driving wheel 15 may be easily absorbed by the transport unit. With around an engagement point a distance to the engagement point of less than 25 centimetres, preferably less than 10 centimetres and most preferably of less than 5 centimetres is meant. With substantially equal a distance to the engagement point of preferably less than 15 centimetres preferably less than 10 and most preferably less than 5 centimetres is meant. In this configuration it may be less likely that the guide mechanism 5 will jam with the rail by the driving forces.

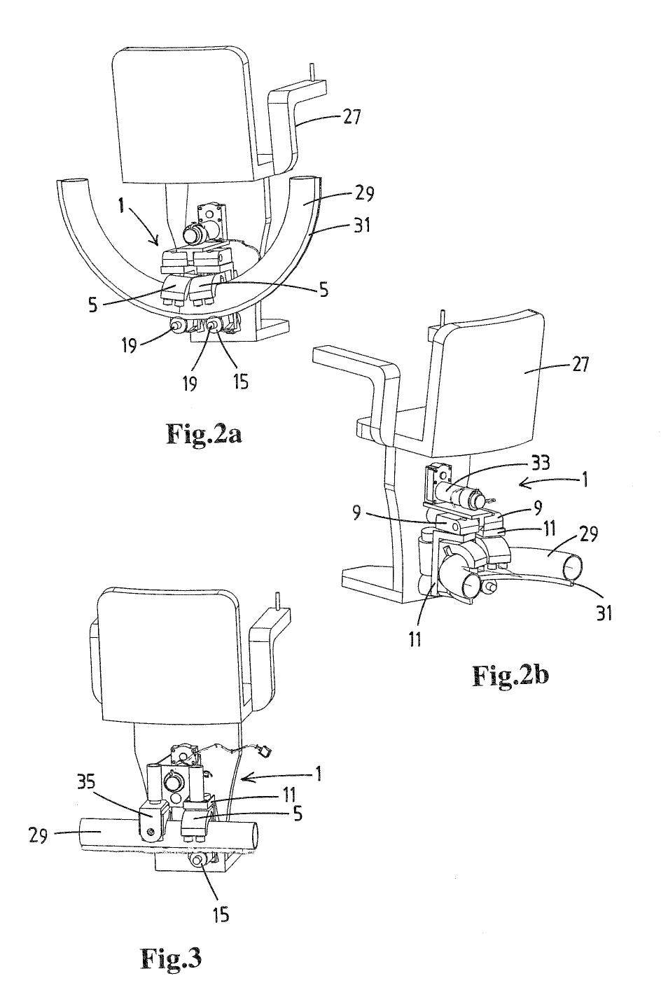

FIG. 2a discloses a stair lift with the transport unit 1 of FIG. 1 and a chair 27 mounted against it in a vertical bend of a rail 29 with a strip 31. The strip 31 may be provided with tooth which may engage with tooth provided to the driving wheel 15 so as to increase grip of the driving wheel on the strip. A gear rack may be provided to the strip 31 for this purpose or the tooth may be provided in the strip. Visible is that in a vertical bend of the rail both guide mechanisms 5 may be rotated around the driving axis 19 so that the guides of the guide mechanisms 5 may follow the rail 29.

FIG. 2b discloses a stair lift with the transport unit 1 of FIG. 1 in a horizontal bend of a rail 29 with a strip 31. The first and second intermediate frame 9 may be rotatable connected with the first and second guide frame 11 around axis 23 (see FIG. 1a). Visible is that in a horizontal bend of the rail both the first and second intermediate frame 9 may be rotated around the axis 23 so as that the guide frames 11 and the guide mechanisms 5 may follow the rail 29. The chair 27 may be connected to the transport unit 1 with a rotating axis driven by a motor 33 so as to keep the chair horizontal during driving over the rail.

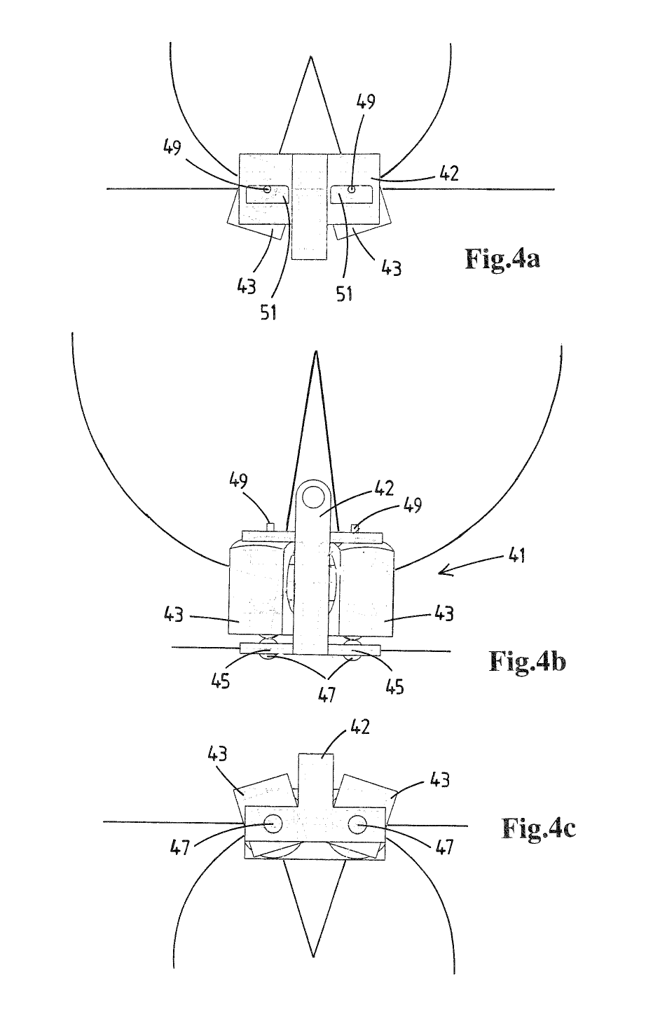

FIG. 3 discloses a further embodiment according to the invention. In this embodiment only one of the guide mechanisms 5 may be provided with a driving wheel 15. The other guide mechanism 35 is only provided with guides which may function to keep the transporting unit 1 in the right position on the rail. The driving axis of the driving wheel 15 may have a bearing in the guide frame 11 and in the guide mechanism 5 similar as the embodiment of FIG. 1a. In this way the driving axis functions to suspend the guide frame 11 from the guide mechanism 5. The transport unit may again comprises a protrusion below the guide frame 11 and which may be moveable in a slot (not shown) in the top of the guide mechanism 5. The protrusion in the slot may function as an end-stop for the rotation of the guide mechanism 5 and may provide a connection with the guide frame 11 above the engagement point of the driving wheel 15 so as to compensate for a torque of the guide mechanism 5 with respect to the guide frame 11 in a direction around the rail 29.

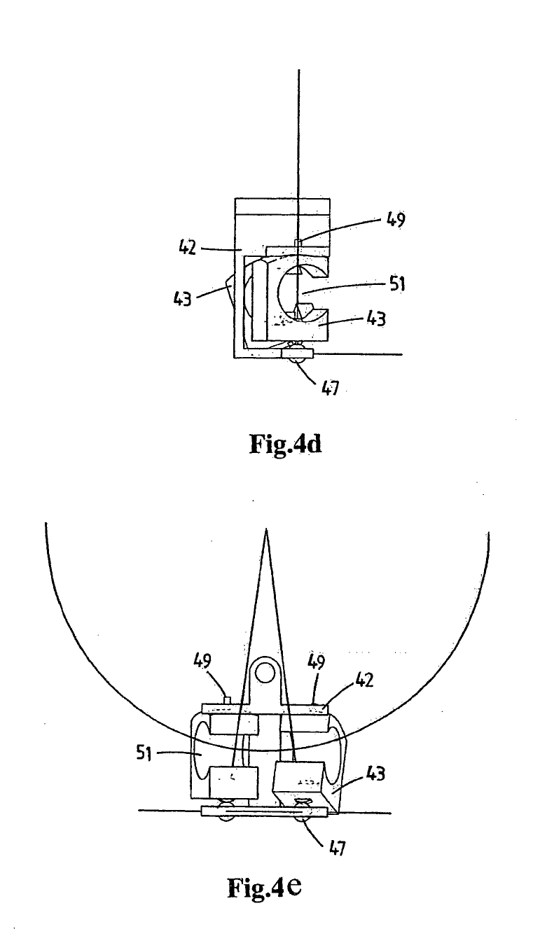

FIG. 4a discloses a top view, FIG. 4b a front side view, FIG. 4c a bottom view, FIG. 4d a side view and FIG. 4f a back side view on a further embodiment according to the invention. A transport unit 41 is provided with a main frame 42 and a guide mechanism 43. The guide mechanism 43 may be provided with at least two guides (not shown) to guide the transport unit along a rail and a drive mechanism provided with a drive wheel for driving the transport unit along the rail by engaging the strip at an engagement point, wherein the main frame 42 may be suspended from the guide mechanism 43 in a vertical position 45 around, substantially equal and/or lower than the engagement point. With around an engagement point a distance to the engagement point of less than 25 centimetres, preferably less than 10 centimetres and most preferably of less than 5 centimetres is meant. With substantially equal a distance to the engagement point of preferably less than 15 centimetres preferably less than 10 and most preferably less than 5 centimetres is meant. The guide mechanism 43 may be provided with a bal bearing 47 which may be provided in a space in the main frame 42 so as to suspend the weight of the mainframe 42 and any weight carried by it. FIG. 4a discloses further a protrusion 49 provided to the drive mechanism 43. The protrusion fits in an opening 51 of the main frame 42. The opening 51 may be large enough to allow the protrusion 49 to move with respect to the main frame 42. In this way the main frame 42 comprises a connection with the guide mechanism 43 in a vertical position above the engagement point so as to compensate for a torque around the rail. The opening 51 in the guide mechanism 45 may be constructed and arranged for receiving the rail.

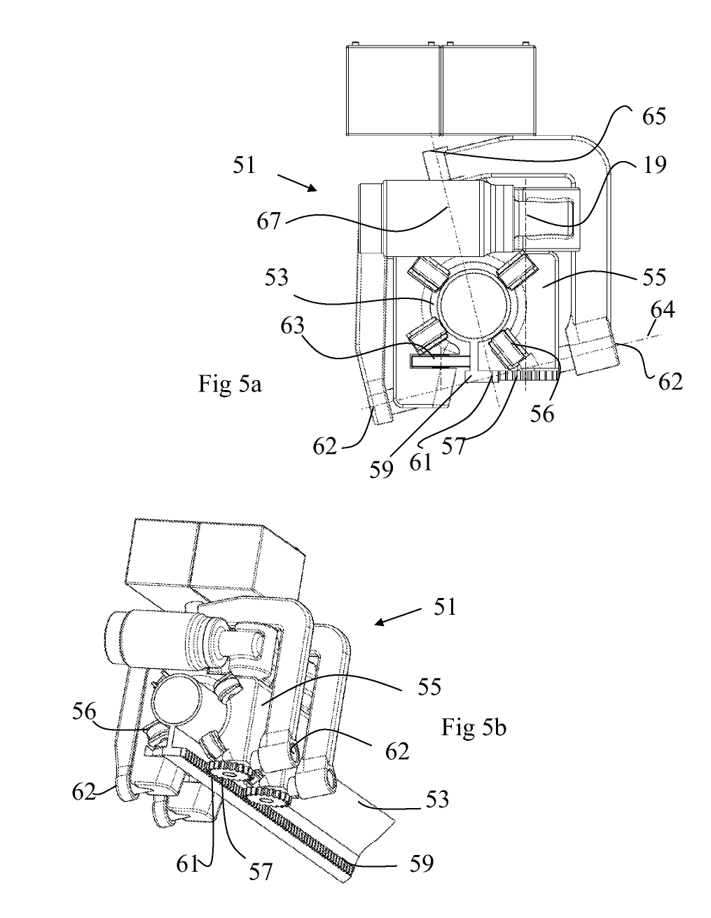

FIG. 5a and b disclose yet a further embodiment of a transport unit 51 constructed and arranged for climbing or descending a slope or stairs along a rail 53. The transport unit 51 comprises a main frame and a guide mechanism 55, the guide mechanism 55 is provided with guides 56 which guide the transport unit along the rail 53 and a drive wheel 57 for driving the transport unit along the rail by engaging the strip 59 at an engagement point 61. The main frame is suspended from the guide mechanism 55 at two bearings 62. The two bearings 62 provide for a rotational first axis 64 for the guide mechanism 55 with respect to the main frame. The first axis 64 may have a position around and/or substantially equal with an engagement point 61 of the driving wheel with the strip 59. With around an engagement point a distance to the engagement point of less than 25 centimetres, preferably less than 10 centimetres and most preferably of less than 5 centimetres is meant. With substantially equal a distance to the engagement point of preferably less than 15 centimetres preferably less than 10 and most preferably less than 5 centimetres is meant. The driving motor 63 may be mounted on the guide mechanism 55 and may drive the driving wheel 57 via an axis 19 being almost perpendicular to the first axis of rotation of the bearings 62. The drive wheel 57 may be almost aligned with the rotational first axis 64 in this case. The influence of forces exerted by the driving wheel 57 may therefore be small and it may be less likely that the guide mechanism 55 may jam with the rail 53 by the driving forces. The guide mechanism may be provided with an extra guide wheel 63 to press the driving wheel 57 on the strip 59. The drive wheel 57 may be a gear wheel engaging with tooth provided to the strip 59 on one side of the strip. The other side of the strip may be flat cooperating with the extra guide wheel 63 without tooth. The main frame may have a rotational bearing 65 for allowing rotation of the guide mechanism 55 around a second axis 67. The first and second axis 64, 67 may be in a plane perpendicular to the rail 53. The second direction may be substantially perpendicular to the first axis. The first and second axis may be in the same plane and cross around or substantially equal to the engagement point 61. The rotational axis 19 of the driving wheel 57 and the position were it may have its bearing in the guide mechanism 55 may be close to the position where the first and second axis 64, 67 cross by having the engagement point around or substantially equal to the position where the first and second axis 64, 67 cross thereby minimizing influence of the torque of the motor on the guide mechanism 55.

While specific embodiments of the invention have been described above, it may be appreciated that the invention may be practiced otherwise than as described. The descriptions above are intended to be illustrative, not limiting. Thus, it may be apparent to one skilled in the art that modifications may be made to the invention as described without departing from the scope of the claims set out below.

1. A transport unit for climbing or descending a slope or stairs along a rail provided with a strip, the transport unit comprising:
a main frame; and
a guide mechanism;
wherein the guide mechanism is provided with at least two guides which guide the transport unit along the rail and a drive wheel for driving the transport unit along the rail by engaging the strip at an engagement point,
wherein the main frame is suspended from the guide mechanism in a position around, substantially equal and/or lower than the engagement point with a bearing for rotation of the guide mechanism with respect to the mainframe.

2. The transport unit according to claim 1, wherein the main frame comprises a connection with the guide mechanism in a position above the engagement point so as to compensate for a torque around the rail.

3. The transport unit according to claim 2, wherein the connection comprises a pin moveable in a slit.

4. The transport unit according to any of claim 1, wherein the transport unit comprises at least two guide mechanisms.

5. The transport unit according to claim 4, wherein a load is suspended from one of the two guide mechanisms.

6. The transport unit according to claim 4, wherein the load is suspended from two of the guide mechanisms.

7. The transport unit according to claim 4, wherein the guide mechanism is provided with a motor for driving the drive wheel.

8. The transport unit according to claim 3, wherein each guide mechanism is provided with a drive wheel.

9. The transport unit according to claim 1, wherein the main frame is suspended from the guide mechanism at a driving axis of the drive wheel.

10. The transport unit according to claim 1, wherein the main frame is suspended from the guide mechanism with a ball bearing.

11. The transport unit according to claim 1, wherein the guide mechanism is rotatable around the X, Y and Z axes with respect to a load being carried by the main frame.

12. The transport unit according to claim 1, wherein a full load of the transport unit is suspended via at least one guide mechanism to the guide.

13. The transport unit according to claim 1, wherein the transport>unit is provided with bearings for rotation of the guide mechanism around a first axis and a second axis, the first and second axes being in a plane perpendicular to the rail.

14. The transport unit according to claim 1, wherein the first and second axis axes cross each other in the rail.

15. A method for transporting -a load along a rail comprising a strip, the method comprising:
engaging a drive wheel provided to a guide mechanism with the strip at an engagement point;
suspending a main frame from the guide mechanism with a bearing being positioned around, substantially equal and/or lower than the engagement point;
rotating the driving wheel so as to drive the guide mechanism along the rail; and
allowing rotation of the guide mechanism with respect to the mainframe around the bearing.
